(19) United States
(12) Patent Application Publication
(10) Pub. No.: US 2008/0080517 A1
(43) Pub. Date: Apr. 3, 2008

(54) System and method for forwarding traffic data in an MPLS VPN

(75) Inventors: Sumantra Roy, Lisle, IL (US); Joseph Wolfe, Lisle, IL (US); Phil Umeki, Chicago, IL (US); David J. Mahar, White Plains, NY (US)

Correspondence Address: AT&T CORP., ROOM 2A207, ONE AT&T WAY, BEDMINSTER, NJ, 07921, US

(73) Assignee: AT & T Corp.

(21) Appl. No.: 11/541,032

(22) Filed: Sep. 28, 2006

(51) Int. Cl. H04L 12/56

(52) U.S. Cl. 370/395.5

(57) ABSTRACT

The present invention provides a system and method for forwarding traffic data in a MPLS VPN network within a telecommunications network. The method comprise a technique for gateway selection in the MPLS VPN by using a combination of recursive floating static routes in the PE routers and conditional route advertisements from the gateway CE routers. This method allows for choice of gateway on a per-PE per-VRF basis.

### FIELD OF THE INVENTION

The present invention generally relates to the field of data communication. More specifically, the present invention relates to techniques for forwarding traffic data in a multiprotocol label switching (MPLS) virtual private networks (VPNs) within a telecommunications network.

### BACKGROUND OF THE INVENTION

Recently, organizations have begun to build “virtual private networks” (VPNs) on top of public networks, such as the Internet to protect data transmitted over public networks. Virtual private network systems often rely on virtual private network gateways which reside on wide area network (WAN) side of a routing apparatus to connect an enterprise side to the Internet. Thus, VPN gateways are in the path of all relevant data traffic between an enterprise site and the public network.

There are different implementations of traditional provider provisioned (PP) VPN architecture applications. One such implementation is muliprotocol label switching (MPLS) VPN. The MPLS VPN architecture mainly comprises a backbone network composed of P (provider router) devices and PE (provider edge router) devices preferably provided by a VPN Service Protocol (ISP) as well as the subscribers' VPN that comprises a plurality of sites and CE (customer edge router) devices. In said devices, P devices are mainly responsible for forwarding MPLS frames. PE devices are the main body to realize MPLS VPN service, and they maintain independent lists of sites in subscribers' VPNs, and detect VPN topologies and learn internal VPN routes. CE devices are common routers, and they connect sites in subscribers' VPNs to PEs, without supporting any MPLS or VPN signaling or protocol.

MPLS VPNS do not intrinsically provide a mechanism for customer edge (CE) routers to route traffic to preferred exit points, also referred to as gateways, connected to the service provider (SP) backbone. Such mechanisms are required when a choice of exit points exist. These exit points can for example be gateways to the public Internet or other services. Customers preferably require the ability to select the gateway by the customer, i.e. the CE router. These mechanisms also need to be aware of the availability of the service past the gateway to the extent possible via network/routing information. Non-availability of the service should result in the gateway being dropped as a possible exit point. An additional requirement faced by service providers is the need to keep the complexity of such mechanisms low. Thus, there is a need to provide a mechanism that allows for ease of implementation and troubleshooting across large service provider (SP) networks.

Many organizations have been planning to deploy a more complex approach for many years utilizing a Border Gateway Protocol (BGP) based approach. However, high development costs for the more complex approach has resulted in this feature not being developed as yet. Complex workarounds such as the use of multiple VRFs in the backbone have been used to handle existing customer requirements. However, these solutions do not scale and cannot keep up with customer requirements.

### SUMMARY OF THE INVENTION

The present invention provides a system and method for forwarding traffic data in MPLS VPNs. The method comprises receiving traffic data from at least one CE router, checking at least one VPN routing table to select at least one gateway within a MPLS backbone for at least one VPN destination. The table comprises at least one gateway specified by the CE router and a logic provided with the specified gateway. The method also comprises configuring a recursive static route in at least one PE router in the MPLS backbone. The recursive static route comprise at least one path to the gateway specified by the CE router. The method further comprises directing traffic data by at least one PE router to a VPN destination via the path to the gateway.

### BRIEF DESCRIPTION OF THE DRAWINGS

FIG. 1 illustrates a MPLS VPN architecture in accordance with one embodiment of the present invention.

FIG. 2 illustrates a MPLS VPN architecture in accordance with another embodiment of the present invention.

FIG. 3 illustrates a MPLS VPN architecture in accordance with a further embodiment of the present invention.

### DETAILED DESCRIPTION OF THE INVENTION

As known in the art, the MPLS VPN defines a mechanism that allows service providers to use their IP backbone (in this case MPLS backbone) to provide VPN services to their customers. A standard PE-CE routing protocol can be used to distribute VPN routing information across the provider's backbone and MPLS is used to forward VPN traffic from one VPN site to another. Alternatively, a Border Gateway Protocol (BGP) can be used to distribute VPN routing information. The Border Gateway Protocol (BGP) is the core routing protocol of the Internet. It works by maintaining a table of IP networks or ‘prefixes’ which designate network reachability between autonomous systems (AS). It is described as a path vector protocol. BGP does not use traditional IGP metrics, but makes routing decisions based on path, network policies and/or rulesets. When using an exterior gateway protocol such as Border Gateway Protocol (BGP) in a network, the routes received have a next hop that is not necessarily directly connected. The IGP is used to “resolve” these next hops. When BGP is running inside an autonomous system (AS), it is referred to as Internal BGP (IBGP Interior Border Gateway Protocol). iBGP routes have an administrative distance of 200. When BGP runs between ASs, it is called External BGP (EBGP Exterior Border Gateway Protocol), and it has an administrative distance of 20.

Typically, VPN comprises a plurality of sites. A customer site is connected to the service provider network by one or more ports, where the service provider associates each port with a VPN routing table, also known as a VPN routing and forwarding (VRF) table. Virtual Routing and Forwarding (VRF) is a technology used in computer networks. It allows multiple instances of a routing table to co-exist within the same router at the same time. Because the routing instances are independent, the same or overlapping IP addresses can be used without conflicting with each other. A VRF may be implemented in a network device by having distinct routing tables, also known as forwarding information bases (FIBs), one per VRF. Alternatively, a network device may have the ability to configure different virtual routers, where each one has its own FIB, not accessible to any other virtual router instance on the same device. VRF technology is commonly found in the ISP marketplace, notably in MPLS VPN configurations. In simple terms, a VRF is a collection of policies that control the connectivity among a set of sites. Such policies may comprise a IP route list, a label-forwarding list, a series of interfaces using the label-forwarding list and management information, router filtering policy, member interface list, etc.

In a MPLS VPN, CE routers forward all traffic to MPLS backbone PE routers. The PE routers then forward traffic using the VPN routing tables. These tables help the PE routers determine the best paths within the backbone for any VPN destination. CE routers cannot by default influence the choice of paths in the backbone. In a case where multiple paths exist to a common destination/service, the VPN customer often requires the ability to select the path for reasons such as load-balancing, latency, routing symmetry, administrative-distance etc. Briefly, load-balancing allows a router to use multiple paths to a destination when forwarding data packets. Latency means network delay and routing symmetry means that forward path and return path are identical. The administrative distance is a measure of relative importance assigned to a protocol, used to determine which route to pick when multiple protocols resolve the same route. Rather than require complex routing interaction between the CE and PE routers, customers prefer to leave routing decisions to the backbone and cannot specify the choice of gateway on a per-PE per VRF basis.

The present invention provides a system and a method for gateway selection in MPLS VPNs by using a combination of recursive floating static routes in MPLS PE routers and conditional route advertisements from gateway CE routers. This method is extended to include the case where the gateway CE is unable to support conditional route advertisements. In this case the MPLS PE routers are able to route correctly in both normal and failure scenarios using MPLS PE rerouting. This method allows for choice of gateway on a per-PE per-VRF basis. Use of the ‘floating’ feature in the PE vrf static routes allows for selection from amongst multiple gateways. This approach's reliance on a static route mechanism ensures minimal additional complexity and configuration overhead from a SP viewpoint. This approach is unique and innovative thus combining several standard routing components in a new way to provide an approach to gateway selection for MPLS VPN's that also incorporates information on gateway availability. It imposes low incremental functionality and configuration requirements on the service provider backbone which is another positive, resulting in it being easily deployable. The features of the present invention are described in a greater detail below.

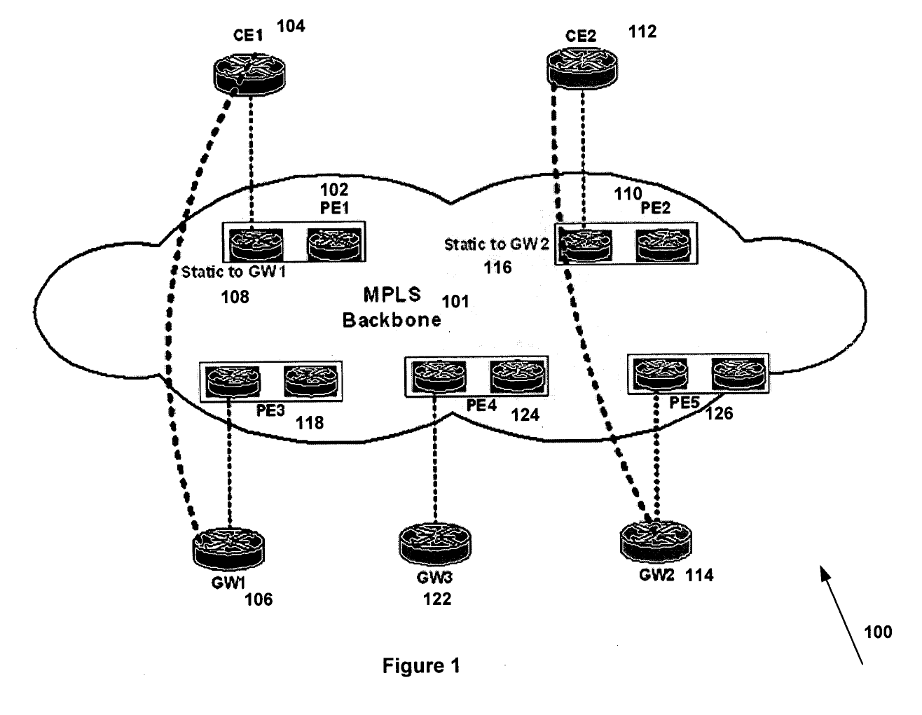

Referring to FIG. 1, there is shown a MPLS VPN architecture 100 in accordance with one embodiment of the present invention. The MPLS VPN architecture 100 includes a MPLS backbone 101 comprising PE routers PE1 102, PE2 110, PE3 118, PE4 124 and PE5 126. The MPLS VPN 100 also comprises CE routers CE1 104, CE2 112 and CE3 120; and gateway routers GW1 106, GW2 114 and GW3 120. In FIG. 1, the PE1 router 102 directs traffic from the CE1 router 104 to the gateway GW1 106 via the backbone 101. This is done by introducing a recursive static route VRF1 108 in a PE1 router 102 of the VRF table that CE1 104 is a part of. The use of a recursive static route in one version, points to a loopback address on the gateway router of choice. This route is added on a per PE per VRF basis. A recursive static route is where the next-hop destination for a static route is not directly connected to the router. The router must do a recursive lookup in its VRF table to resolve the next-hop for the route. This provides flexibility in choosing the next-hop based on dynamic changes to the VRF table.

The recursive static route VRF1 108 is introduced in the PE1 router 102 as shown in FIG. 1 This recursive static route 108 points to a loopback address on the gateway router of choice, which in this case is GW1 106. Similarly PE2 router 110 directs traffic from CE2 router 112 to gateway GW2 114 such that a recursive static route VRF2 116 is introduced in the PE2 router 110 as shown in FIG. 1. This recursive static route 116 points to a loopback address on the gateway router GW2 114. Note that if the recursive static routes were not present, traffic from both CE1 104 and CE2 112 would be routed to a common gateway router. An example of the recursive static route 108 in PE1 102 is given below:
Ip route VRF1 108 {w.x.y.z} next-hop GW1
Where:
   w.x.y.z is the destination network &
   GW1 is the loopback address of the gateway router GW1 106

Similarly, the recursive static route in PE2 would be:
Ip route VRF2 116 {w.x.y.z} next-hop GW2
Where:
   w.x.y.z is the destination network &
   GW2 is the loopback address of the gateway router GW2 114

In the above example, network w.x.y.z is a common destination network that is being advertised by both gateways GW1 106 and GW2 114.

The standard PE-CE routing protocols also cause network w.x.y.z to be advertised and learned by the PEs using the Multi Protocol Internal Border Gateway Protocol (MPiBGP). However, the presence of the static route suppresses the MPiBGP route, this is the result of static routes having a lower administrative distance as compared to MPiBGP.

The static routes VRF1 108 and VRF2 116 are valid only as long as the PE routers PE1 102 and PE2 110 are able to resolve the path to loopback addresses GW1 106 and GW2 114. These are learnt via standard PE-CE routing protocols. If for example the GW1 106 router becomes non-functional, address GW1 is no longer advertised to the PEs. In that case PE1 102 withdraws the static route VRF1 108 to network w.x.y.z from its routing table, i.e. the VRF table. With the static route 108 withdrawn, PE1 102 uses the MPiBGP path to network w.x.y.z. This can result in forwarding to any other available gateway depending upon MPiBGP determination. And, if more than two gateways exist and a specific order of selection is required, a ‘floating’ option can be added to the recursive static route 108 in PE1 102 as follows:
Ip route VRF1 108 {w.x.y.z} next-hop GW1 admin-distance 5
Ip route VRF1 108 {w.x.y.z} next-hop GW2 admin-distance 10
Ip route VRF1 108 {w.x.y.z} next-hop GW3 admin-distance 15

Note that the lower admin-distance results in a higher preference of that route. This approach is known as a floating static route. The PE2 router 110 can implement a similar order in the example described above or can alternatively implement a different order of preference for its gateway selection.

Thus the use of the recursive feature ensures that if the static route is disabled for some reason the gateway router loopback address is unreachable. The additional use of the floating feature in the static route allows for multiple gateways to be defined in the order of preference. This method results in very minor incremental complexity. The only feature dependence is the recursive resolution of the routing next-hop on the ingress PE. In other words, the recursive static routes are resolved based on BGP routing table lookups. All other P and PE routers that comprise the SP backbone remain unaffected. Note that there may preferably be multiple layers of recursions which indicates that the static route could depend on a dynamic route which could depend on yet another dynamic route and that could go on until the a path is resolved.

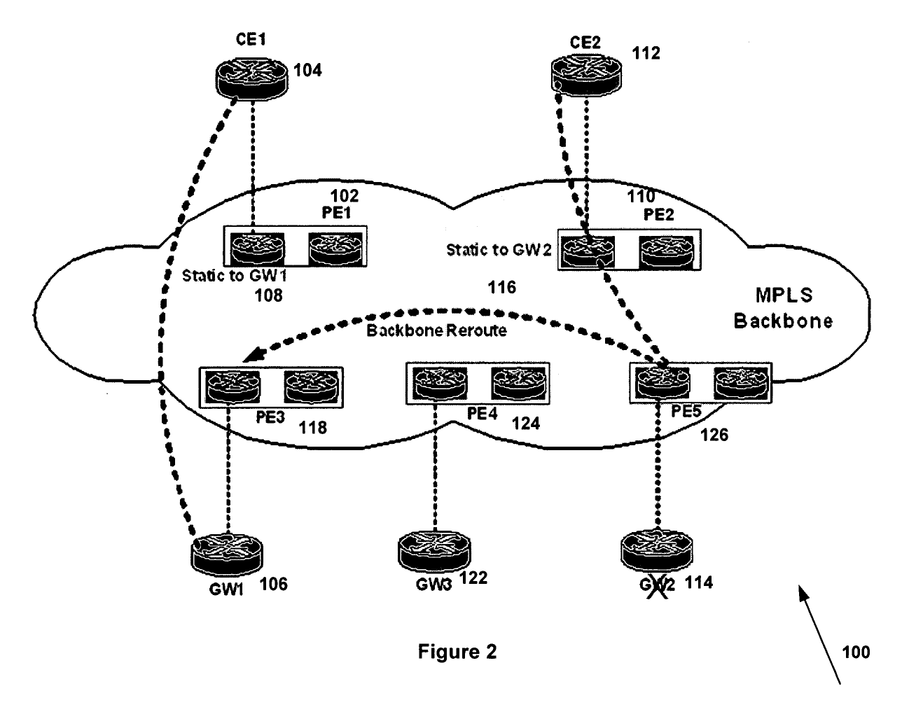

In another embodiment of the present invention, there is provided a MPLS VPN architecture 100 of FIG. 1 with a scenario that the gateway routers GW1 106, GW2 114 and GW3 122 are unable to support conditional advertisement. This solution is depicted in FIG. 2. In this case, for example, GW3 122 continues to advertise its loopback address even though it is unable to reach the destination network w.x.y.z. In this case, PE5 126 learns the route to GW2 114 through loopback, but does not have a route for the network w.x.y.z from GW2 114. It does however have a route to the network w.x.y.z from GW1 106 and GW3 122. In this example as shown in FIG. 2, it is assumed that GW1 106 is preferred by MPiBGP for reaching the destination network w.x.y.z. Thus, traffic from the CE2 112 is forwarded to PE2 110 as usual, which then forwards traffic to PE5 126 based on the static recursive route VRF2 116 in the PE2 110. This route has not been withdrawn since PE2 110 can resolve the GW3 122 loopback address.

Once the traffic is received at PE5 126, the vrf routing table will determine that the packets must be forwarded to PE3 118. The traffic re-enters the MPLS backbone and emerges at PE3 118. The vrf routing table in PE3 118 then forwards the traffic to GW1 106. This embodiment, while not differing from the case where conditional advertisements are supported on the Gateways CEs in terms of the configuration (as shown in FIG. 1), does require the PE routers to have the ability to redirect traffic within the backbone 101. MPLS frames are de-encapsulated into IP packets, a route lookup is performed, the packets are re-encapsulated in MPLS frames and sent back into the SP network. This results in some additional feature complexity on the PE that performs this function, which is the PE5 126 in this example. There are also traffic engineering implications for backbone capacity management and latency issues to consider.

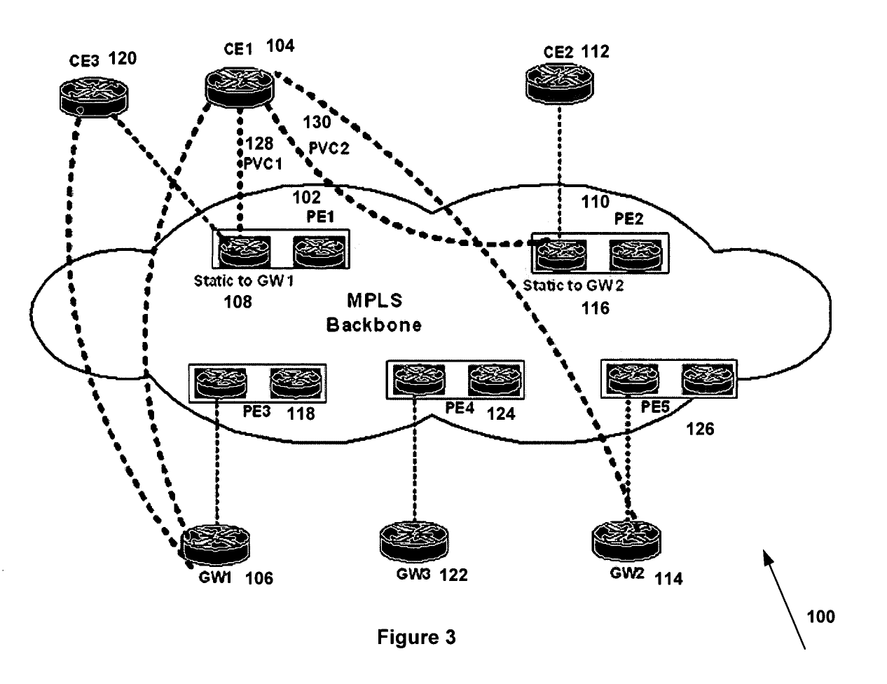

In a further embodiment of the present invention, as illustrated in FIG. 3, there is provided a MPLS VPN architecture 100 of FIG. 1 which considers a case scenario where a particular non-Gateway CE, for example CE1 104 or CE2 112 in the figure requires load-balancing to two gateways. One approach to solving this is by defining two static routes in the ingress PE. For example, to support CE1 104 load-balancing its traffic for the network w.x.y.z via both GW1 106 and GW2 114, the VRF1 108 routing table on the PE1 102 would have the following entries:
Ip route VRF1-108 {w.x.y.z} next-hop GW1
Ip route VRF1 108 {w.x.y.z} next-hop GW2

Depending on additional (standard) underlying forwarding mechanisms this would result in per-flow or per-packet load-balancing to the two gateways. Since there are two equal cost routes to destination w.x.y.z, traffic will load-balance over the two routes/paths.

One variation to this situation occurs when there are multiple customer CEs homed to a PE router, and load-balancing is required for a specific CE only. The solution is to run two PVCs, PVC1 128 and PVC2 130 from the CE1 104 requiring load-balancing, one each terminating on Pes, i.e. PE1 102 and PE2 110 that provide the required routing. PVC is a permanent virtual circuit. The idea here is to connect a CE to two PEs using a single physical link. By defining two PVCs on the physical link and terminating them on the two PEs respectively, two logical connections are created that provides the required connectivity. FIG. 3 as shown also depicts this variation. PVCs 128 and 130 from CE1 104 to PE1 102 and PE2 110 ensure that traffic from CE to network w.x.y.z is load-balanced via GW1 106 and GW2 114. Traffic for the same destination originating in CE3 120 is forwarded via GW1 106 only.

An additional variation requires the definition of a 2^{nd} vrf to support load-balancing on the local PE. This removes the need to run a PVC to a non-local PE. Routes can be exported to this second vrf to ensure that its table contains the w.x.y.z route via GW3. This approach is more complex from a SP configuration and support perspective, but can be implemented if issues such as backbone capacity or latency become overriding issues. The PE router has many VRFs, each one helping define a VPN. And VPN is created in this approach with its own set of recursive static routes. By connecting the CE to the original VRF and this 2^{nd} one, and by load-balancing between the two, the CE can now load-balance between two gateways over the MPLS backbone.

Although various embodiments that incorporate the teachings of the present invention have been shown and described in detail herein, those skilled in the art can readily devise many other varied embodiments that still incorporate these teachings without departing from the spirit and the scope of the invention.

1. A method for forwarding traffic data in MPLS VPNs within a telecommunications network, the method comprising the steps of:
receiving traffic data from at least one CE router;
checking at least one VPN routing table to select at least one gateway within a MPLS backbone for at least one VPN destination, wherein said table comprises at least one gateway specified by the CE router and a logic provided with said specified gateway;
configuring a recursive static route in at least one PE router in the MPLS backbone, wherein said recursive static route comprise at least one path to the gateway specified by the CE router; and
directing the traffic data to the VPN destination via said path to the gateway specified by the CE router, said traffic directed by the at least one PE router.

2. The method of claim 1 wherein said table comprises at least one gateway not specified by the CE router and the logic with said gateway, wherein said logic comprises of load-balancing, latency, routing symmetry, admin-distance.

3. The method of claim 2 wherein said recursive static route comprises multiple paths dependent on each other.

4. The method of claim 3 further comprising searching the recursive static route according to address of the VPN destination.

5. The method of claim 4 further comprising choosing said path according to an address of a next hop in the recursive static route to direct the traffic data to one of the PE routers, wherein one of the PE routers correspond to the address in the next hop.

6. The method of claim 3 wherein said recursive static route is a floating recursive static route when more than two gateways exist to direct the traffic data to the VPN destination, wherein the floating recursive static route comprises an order of processing of said multiple paths dependent on each other.

7. The method of claim 5 further comprising:
withdrawing the recursive static route in one of the PE router upon non-function of the gateway specified by the CE router.

8. The method of claim 7 further comprising:
directing the traffic data to the VPN destination via a gateway other than the gateway specified by the CE router.

9. The method of claim 7 further comprising:
rerouting the traffic data from one of the PE routers to other of the PE routers upon non-function of the selected gateway.

10. A multiprotocol label switching virtual private network (MLPS VPN) comprising:
customer edge (CE) routers and gateway routers in a subscriber's virtual private network (VPN);
a MPLS backbone network having provider edge (PE) routers connected to the CE routers and the gateway routers; wherein each of the PE routers includes circuitry for:
(i) receiving traffic data from the CE router;
(ii) checking at least one VPN routing table to select at least one of the gateway routes within the MPLS backbone for at least one VPN destination, said table comprises at least one of the gateway router specified by the CE router and a logic provided with said specified gateway;
(iii) configuring a recursive static route to include at least one path to the gateway router specified by the CE router; and
(iv) directing traffic data to a VPN destination via said path to the gateway router specified by the CE router.
